(19) United States
(12) Patent Application Publication
(10) Pub. No.: US 2016/0371071 A1
(43) Pub. Date: Dec. 22, 2016

(54) ACCOUNT-BASED SOFTWARE UPGRADES IN A MULTI-TENANT ECOSYSTEM

(71) Applicant: Dell Software Inc., Round Rock, TX (US)

(72) Inventor: George Edward Reese, Wayzata, MN (US)

(21) Appl. No.: 14/741,021

(22) Filed: Jun. 16, 2015

(51) Int. Cl. G06F 9/445; H04L 29/08; G06F 9/44

(52) U.S. Cl. CPC G06F 8/65; G06F 8/71; H04L 67/10; H04L 67/34

(57) ABSTRACT

A scalable infrastructure containing multiple computer devices may be used for executing a Software-as-a-Service (SaaS) software application. The multiple computer devices of the infrastructure may be divided into several collections of computer devices. Each collection of computer devices is used to execute a different version of the SaaS software application (e.g., a “legacy” version, a “stable” version, and a new “development” version). Different user accounts belonging to a customer organization can then each use one of these SaaS software versions, with requests from each user account being interpreted and routed by an input management module of the infrastructure to the appropriate computer set that executes the appropriate SaaS software version. The appropriate computer set then provides the SaaS service to a user computer device or web server that serves the user account. The SaaS software version used by the user account can be upgraded by the user account.

### BACKGROUND OF THE INVENTION

1. Field of the Invention

The present invention generally relates to software version management. More specifically, the present invention relates to an infrastructure for account-based software upgrades in a multi-tenant ecosystem.

2. Description of the Related Art

A Software-As-A-Service (SaaS) application is a software application that is executed by a first computer, or a first set of computers, in order to provide a service for a second computer, or a second set of computers. The service may be provided through an application programming interface (API), an Internet website or portal, or some combination thereof.

In a typical Software-As-A-Service (SaaS) environment, software updates and software upgrades are often thrust upon customers (e.g., businesses or organizations using the SaaS service) at the whim of the SaaS provider. Modern software development trends encourage rapid development cycles and frequent software updates, which can create change-management issues for customers who have adopted SaaS solutions. Such change-management issues can be very resource-intensive to manage, can require additional employees and employee training by the customer, and can cause issues with products built/sold by the customer.

Occasionally, a SaaS provider may set up a separate environment to be updated on a different schedule for a particularly important customer who is using the SaaS service in an environment where changes can be risky. Even in such situations, however, the SaaS provider is in control of this environment, and customer must go through the SaaS provider any time a change is desired.

A customer (e.g., a business or organization using the SaaS service) may in some cases wish to run multiple versions of the SaaS service. For example, the customer may wish to run a tested and stable version of the SaaS service supporting a “stable” version of a product. The customer may wish to run a fully-updated newer version of the SaaS service for a “development” version of a product. The customer may also wish to occasionally run an older version of the SaaS service for a “legacy” version of a product. This is impossible to do with typical SaaS services.

Therefore, there is a need for improved software versioning infrastructure.

### SUMMARY OF THE CLAIMED INVENTION

One exemplary method for software version management may include receiving a first service request from a first user computer device, the first service request requesting a first service to be provided to a first recipient computer device associated with the first user account, the first service to be a provided by a first version of a Software-as-a-Service software application. The method may include generating a first version-specific request based on the first service request. The method may also include transmitting the first version-specific request to a first computer set, the first computer set including one or more service computer devices, where each service computer device of the first computer set executes first instructions associated with the first version of the Software-as-a-Service software application, and wherein execution of the first instructions by the first computer set provides the first service to the first recipient computer device.

One exemplary system for software version management includes a first computer set, the first computer set including a first one or more network-connected service computer devices executing a first set of instructions stored at a first memory associated with the first computer set. The first set of instructions may be for executing a first version of a software-as-a-service application to provide a first service to a first recipient computer device that is logged into the first user account upon receiving a first service request from the first user account. The system may also include a second computer set, the second computer set including a second one or more network-connected computer devices executing a second set of instructions stored at a second memory associated with the second computer set. The second set of instructions may also be for executing a second version of a software-as-a-service application to provide a second service to a second recipient computer device that is logged into the second user account upon receiving a second service request from the second user account.

One exemplary non-transitory computer-readable storage medium may have embodied thereon a program executable by a processor to perform a method for software version management. The exemplary program method may include receiving a first service request from a first user account, the first service request requesting that a first service be provided to a first recipient computer device associated with the first user account, the first service to be a provided by a first version of a Software-as-a-Service software application. The method may include generating a first version-specific request based on the first service request. The method may also include transmitting the first version-specific request to a first computer set, the first computer set including one or more service computer devices, where each service computer device of the first computer set executes first instructions associated with the first version of the Software-as-a-Service software application, and wherein execution of the first instructions by the first computer set provides the first service to the first recipient computer device.

### BRIEF DESCRIPTION OF THE FIGS

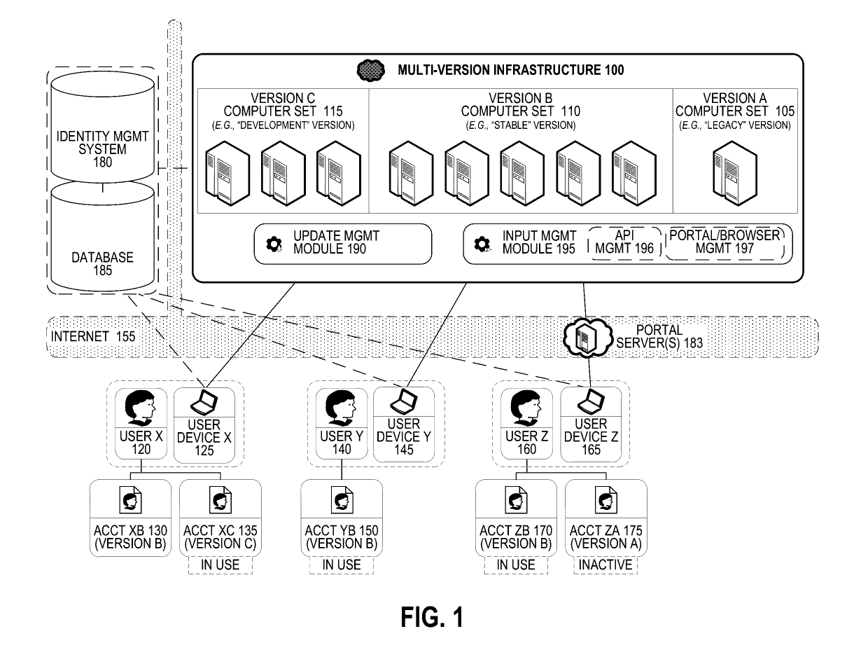

FIG. 1 illustrates an exemplary account-based software upgrade ecosystem.

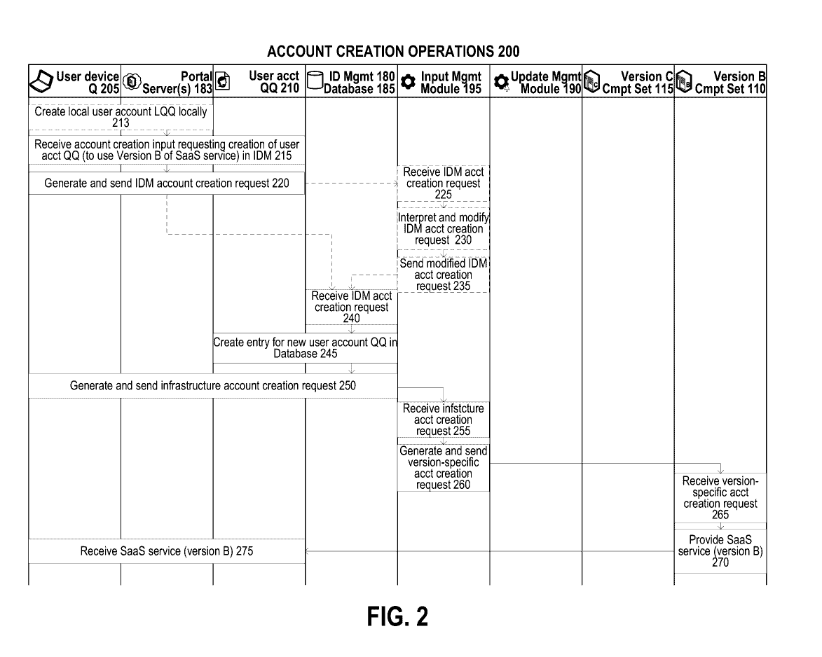

FIG. 2 is a flow diagram illustrating exemplary account creation operations of an exemplary software upgrade ecosystem.

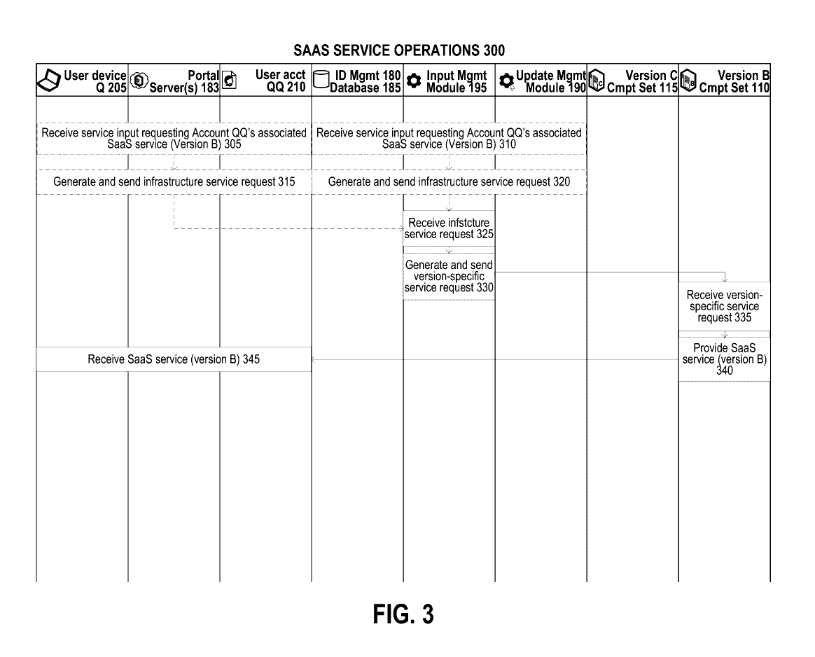

FIG. 3 is a flow diagram illustrating exemplary Software-as-a-Service service operations of an exemplary software upgrade ecosystem.

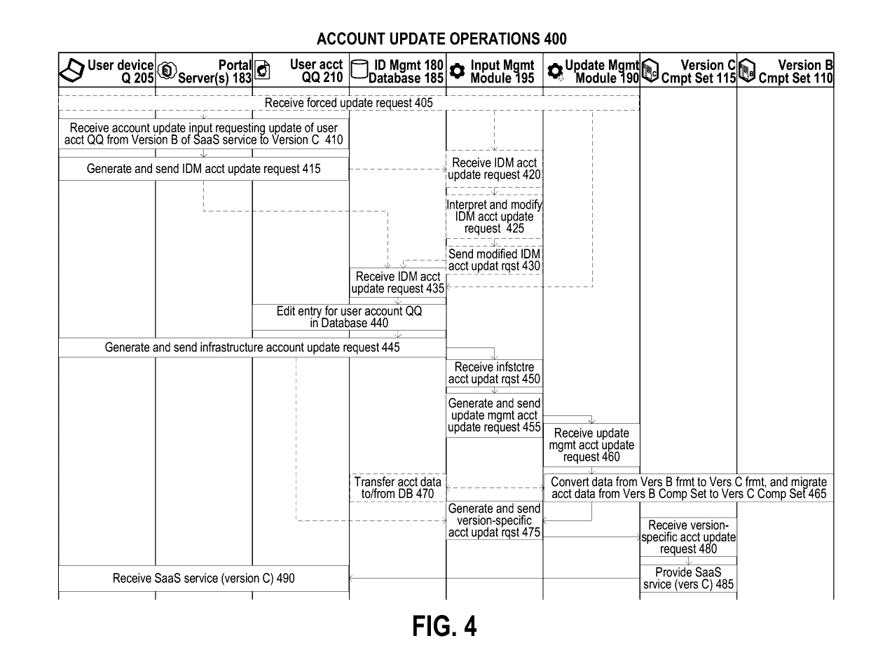

FIG. 4 is a flow diagram illustrating exemplary account update operations of an exemplary software upgrade ecosystem.

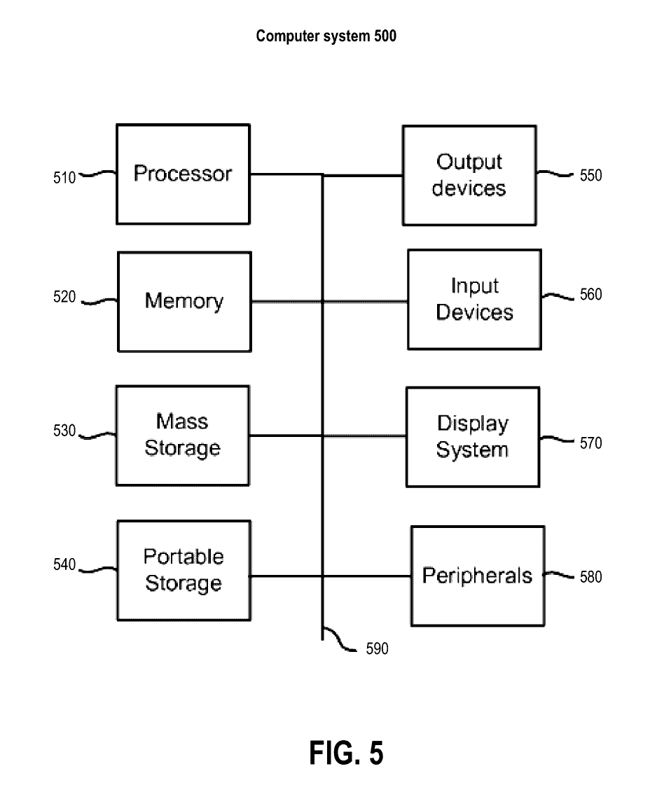

FIG. 5 is a block diagram of an exemplary computing device that may be used to implement an embodiment of the present invention.

### DETAILED DESCRIPTION

Embodiments of the present invention are directed generally to systems and methods related to an infrastructure for account-based software upgrades in a multi-tenant ecosystem. A scalable infrastructure containing multiple computer devices may be used for executing a Software-as-a-Service (SaaS) software application. The multiple computer devices of the infrastructure may be divided into several collections of computer devices. Each collection of computer devices is used to execute a different version of the SaaS software application (e.g., an old “legacy” version, a “stable” version, and a new “development” version). Different user accounts belonging to a customer organization can then each use one of these SaaS software versions, with requests from each user account being interpreted and routed by an input management module of the infrastructure to the appropriate computer set that executes the appropriate SaaS software version. The appropriate computer set then provides the SaaS service to a user computer device or web server that serves the user account. The SaaS software version used by the user account can be upgraded by the user account.

FIG. 1 illustrates an exemplary account-based software upgrade ecosystem. The account-based software upgrade ecosystem of FIG. 1 includes a multi-version infrastructure 100. The multi-version infrastructure 100 may include an update management module 190, which may be a hardware module, a software module, or some combination thereof. The multi-version infrastructure 100 may include an input management module 195, which may include application programming interface (API) management functions 196, network portal/browser management functions 197, or some combination thereof. The input management module 195 may be a hardware module, a software module, or some combination thereof.

The multi-version infrastructure 100 may also include a number of service computer devices which may be divided into multiple computer sets. Each computer set may include one or more service computer devices. Each computer set may execute a different version of a software application, which may be a Software-as-a-Service (SaaS) software application. For example, the multi-version infrastructure 100 includes three (3) computer sets executing three (3) different versions of a software application. These three computer sets are labeled as the Version A Computer Set 105 (executing a “legacy” Version A of the software application), the Version B Computer Set 110 (executing a “stable” Version B of the software application), and the Version C Computer Set 115 (executing a “development” Version C of the software application). The service computer devices of the multi-version infrastructure 100 may include multiple service computer devices connected in a network (e.g., a local area network or wireless local area network), or may include multiple service computer devices distributed throughout the Internet, or may include some combination thereof, and may include physical machines, virtual machines, or some combination thereof.

The software application executed by the multi-version infrastructure 100 may be a Software-as-a-Service (SaaS) software application. This means that the software application may provide service(s) to the user device(s) on demand as requested by the user device(s). Such a request can then be interpreted by the input management module 195. In particular, such a request from a user device can originate from software that is native to the user device (e.g., a document/office software, a web browser, or an operating system), and can go directly to the multi-version infrastructure 100 to be interpreted by the API management functions 196 of the input management module 195. Such a request can alternately originate from one or more portal server(s) 183, or pass through one or more portal server(s) 183 after originating from a user device (e.g., user device Z 165 of FIG. 1). The one or more portal server(s) 183 may include portal servers 183 connected to user devices through the public internet (e.g., the connection between User Device Z 165 and Portal Server(s) 183 located in the Internet 155 shown in FIG. 1) and/or may include portal servers 183 within the same private network as user devices. The one or more portal server(s) may then host a network portal, which may be a public internet portal (e.g., a public website) or a private intranet portal (e.g., a private network portal). The network portal may optionally include identity protections, such as account-based password protections which may be associated with or separate from the identity management system 180 and database 185.

Such SaaS service(s) can include numerous functions, which can be performed at the multi-version infrastructure 100, at the portal server(s) 183 (e.g., as authorized by the software application run by the multi-version infrastructure 100), at the user device(s) (e.g., as authorized by the software application run by the multi-version infrastructure 100), or some combination thereof. The SaaS software application service may, for example, include functions such as storing data at the multi-version infrastructure 100 and/or database 185, retrieving data stored at the multi-version infrastructure 100 and/or database 185, performing processing or calculation functions at the multi-version infrastructure 100, or allowing the user device(s) to perform local user device functions. Such local user device functions can include, for example, storing/receiving/sending data, executing a client-device-based software application, or performing local processing or calculation functions.

A “version” of the software application executed by the multi-version infrastructure 100, such as a SaaS software application, may identify a particular frozen “stage” in an ongoing development of the software application. For example, Version A of the software application of FIG. 1 may be a “legacy” version, a term commonly used to refer to an old or outdated version of a software application. Such older “legacy” versions typically include binary files compiled a longer time ago from older versions of the software application's source code. Older “legacy” versions of software sometimes do not work properly with other more modern software or hardware innovations, and can sometimes include known unpatched known security vulnerabilities or unfixed bugs.

Version B of the software application of FIG. 1 may, for example, be a “stable” version, a term commonly used to refer to a version of a software application that is relatively up-to-date and modern (though typically is not the newest available version) and is extensively tested. “Stable” software versions typically work with most modern software and hardware innovations, have most known security vulnerabilities patched, have most known bugs fixed. “Stable” software versions of SaaS software may be useful to use with “production” systems or systems that are relied upon by customers of the SaaS service (e.g., customer businesses/organizations with many associated user accounts) to support the customer's own products (which in turn may be relied upon by the customer's own customers).

Version C of the software application of FIG. 1 may, for example, be a “development” version, a term commonly used to refer a very new version of a software application that is very up-to-date and modern, but often has not yet had a chance to be as extensively tested as the “stable” version. “Development” versions often work with most modern software and hardware innovations, sometimes even more so or better than the “stable” versions, have many known security vulnerabilities patched (sometimes more than the “stable” versions), have many known bugs fixed (sometimes more than the “stable versions). “Development” versions can also introduce new unknown bugs and unknown security vulnerabilities, however, and sometimes no longer work with older software or hardware. “Development” software versions of SaaS software may be useful for the customer business/organization when the customer business/organization is trying to develop its own upgraded product, particularly if the upgraded product is to make use of new features (e.g., new functions of the service) that are new to the “Development” version of the SaaS software application.

The account-based software upgrade ecosystem of FIG. 1 also includes multiple users and user devices used by those users. In particular, the exemplary ecosystem of FIG. 1 includes User X 120 using User Device X 125, User Y 140 using User Device Y 145, and User Z 160 using User Device Z 165. Each user may have one or more user accounts, and not all of these user accounts need to be on the same user device (though the user accounts illustrated in FIG. 1 are). Each user device may have one or more user accounts, and not all of these user accounts need to be associated with the same user (though the user accounts illustrated in FIG. 1 are).

Each user account may be associated with a single version of the software application, though not all of the user accounts in the ecosystem need to be associated with the same version of the software application. For example, User Account XB 130 (associated with User X 120 and User Device X 125) is associated with Version B of the software application, and therefore the Version B Computer Set 110 will execute Version B of the software application to provide User Account XB 130 with services associated with Version B of the software application. Similarly, User Account XC 135 (associated with User X 120 and User Device X 125) is associated with Version C of the software application, and therefore the Version C Computer Set 115 will execute Version C of the software application to provide User Account XC 135 with services associated with Version C of the software application. Similarly, User Account YB 150 (associated with User Y 140 and User Device Y 145) is associated with Version B of the software application, and therefore the Version B Computer Set 110 will execute Version B of the software application to provide User Account YB 150 with services associated with Version B of the software application. Similarly, User Account ZB 170 (associated with User Z 160 and User Device Z 165) is associated with Version B of the software application, and therefore the Version B Computer Set 110 will execute Version B of the software application to provide User Account ZB 170 with services associated with Version B of the software application. Similarly, User Account ZA 175 (associated with User Z 160 and User Device Z 165) is associated with Version A of the software application, and therefore the Version A Computer Set 105 will execute Version A of the software application to provide User Account ZA 175 with services associated with Version A of the software application.

The number of service computer devices in each computer set may be different, and may be based on, for example, how many user accounts are currently using (or are currently able to use) the version of the software application that that computer set is executing.

For example, User Account YB 150 and User Account ZB 170 are both identified in FIG. 1 as currently in use, and are both identified as currently using Version B (the “stable” version) of the software application. Further, User Account XB 130 is also identified as using Version B of the software application, even though User Account XB 130 is not currently in use. Therefore, the Version B Computer Set 110 is illustrated as containing five (5) service computer devices to support current usage by User Account YB 150 and User Account ZB 170 and potential future usage by User Account XB 130.

On the other hand, only User Account XC 135 is identified in FIG. 1 as using Version C (the “development” version) of the software application. User Account XC 135 is identified as currently in use. Therefore, the Version C Computer Set 115 is illustrated as containing three (3) service computer devices to support current usage by User Account XC 135.

Finally, only User Account ZA 175 is identified in FIG. 1 as using Version A of the software application. User Account ZA 175 is identified as inactive, which could mean that it is no longer a functional user account, that it has been disabled by User Z 160 or by an “administrator” user account (e.g., through an “administrator” user device or the portal servers 183) with administrative privileges (e.g., according to the Identity Management System 180 and/or Database 185), or simply that it has not been used for a predetermined duration of time (e.g., 5 months). Therefore, the Version A Computer Set 105 is illustrated as containing one (1) service computer devices to support potential usage by User Account ZA 105. In some cases, a not-currently-in-use computer set such as Version A Computer Set 105 may include zero (0) service computer devices, and a service computer device may be added to the not-currently-in-use computer set as needed if a user account associated with Version A of the software application (e.g., User Account ZA 175) decides to log in and use Version A of the software application.

The number of service computer devices in each computer set may be dynamically scalable as different needs arise. For example, if more users accounts upgrade from using Version B of the software application to Version C of the software application, a service computer device may be added to the Version C Computer Set 115, either by allocating an unused service computer device from a pool of unused service computer devices, or by reallocating an in-use service computer device from another computer set (e.g., from Version B Computer 110).

In some cases, when a particular user account is updated (e.g., FIG. 4) from using one version of the SaaS service (e.g., Version B) to an updated version of the SaaS service (e.g., Version C), the individual service computer device providing that SaaS service for that user account may be transitioned from running the pre-update version (e.g., Version B) to running the post-update version (e.g., Version C) so that the point of contact does not change. In other cases, the Update Management Module 190 may simply point the user account to a new service computer device running the updated version of the SaaS software application and migrate any data that should be migrated.

In some cases, each computer set may be afforded “just enough” service computer devices to perform the requested service for the user accounts currently requesting SaaS service in each version. Alternately, if there are enough service computer devices, the number of service computer devices per computer set may instead be allocated based on where allocation of more service computer devices can best increase performance of the one or more versions of the SaaS service, where allocation of more service computer devices can best increase energy-efficiency of providing one or more versions of the SaaS service, where allocation of more service computer devices can best increase memory efficiency of providing one or more versions of the SaaS service, or similar metrics.

The account-based software upgrade ecosystem of FIG. 1 may also include an Identity Management System (“IDM”) 180. The IDM 185 may store data about the user account of the account-based software upgrade ecosystem (e.g., User Account XB 130, User Account XC 135, User Account YB 150, User Account ZB 170, User Account 175 in FIG. 1). In particular, the IDM 185 may be used to store information regarding which version of the SaaS application provides services to each particular user account. The IDM 185 may also store other information for each user account, such as roles and privileges associated with the user account, authentication information (e.g., login/password/certificate information), authorization information, security/encryption keys, Public Key Infrastructure (“PKI”) public keys/certificates, personal settings associated with the user account, data associated with the user account (e.g., personal or work-related data), active directory data, access control data, digital identity data, password management data, workflow data, and other account-specific information. The IDM 180 may include one or more IDM computer devices, which may be connected by a network, distributed throughout the internet, or some combination thereof, and may include physical machines, virtual machines, or some combination thereof. The IDM computer device(s) executing the IDM 185 may in some cases be intentionally distributed apart from the service computer devices of the multi-version infrastructure 100.

The account-based software upgrade ecosystem of FIG. 1 may also include a database 185. The database 185 may be associated with the IDM 180, and may be used by the IDM 180 to store data collected by the IDM 180 as described above. The database 185 may alternately be separate from the IDM 185, and may be used to store data associated with one or more user accounts (e.g., data accessible to a user through a user device when the user is logged into to the user account at the user device). The database 185 may be stored by database computer devices, which may be connected by a network, distributed throughout the internet, or some combination thereof, and may include physical machines, virtual machines, or some combination thereof.

While the database 185 is referred to as a “database,” it should be understood that it may alternately be any data structure that can hold one or more pieces of data, such as a database, a table, a list, a matrix, an array, an arraylist, a tree, a hash table, a hash map, a string, a map, a graph, a flat data sequence file, an image, a queue, a heap, a memory, a stack, a set of registers, a set of records, a tree, a tuple, a union, or a similar data structure.

The database 185 may, in some cases, store data associated with one or more user accounts. The database 185 may in some cases store data associated with a particular user (e.g. User X 120), and may provide the data associated with that user (e.g. User X 120) to all user accounts associated with that user (e.g. User Account XB 130 and User Account XC 135). This may allow a user to have persistent data storage across different user accounts using different SaaS software versions. Similarly, the database 185 may in some cases store data associated with a particular user device (e.g., User Device Z 165) and may provide the data associated with that user device (e.g., User Device Z 165) to all user accounts associated with that user device (e.g. User Account ZB 170 and User Account ZA 175). This may allow different users logging into a single user device to have persistent data storage accessible by the user device but stored elsewhere.

The multi-version infrastructure 100 of FIG. 1 may also be associated with an Input Management Module 195, which may be used to route and manage requests from at least one user device or from network portal server(s) 183 that are communicatively coupled to at least one user device. The Input Management Module 195 may include API management functions 196 that, for example, allow the Input Management Module 195 to interpret API commands between the multi-version infrastructure 100 and a user device, and/or API commands between the multi-version infrastructure 100 and the IDM 180, and/or API commands between the multi-version infrastructure 100 and the database 185, and/or API commands between sub-systems of the multi-version infrastructure 100 (e.g., API commands between the Update Management Module 190 and the service computer devices, or API commands between service computer devices). The Input Management Module 195 may include portal/browser management functions 197 that, for example, allow the Input Management Module 195 to interpret commands from network portal server(s) 183 (e.g., hosting a network-based portal or service) and/or from the browser that is accessing the portal hosted at the network portal server(s) 183 (e.g., a browser executed by User Device Z 165 of FIG. 1). Commands from the network portal/service may be based on commands from a user device, or may originate as commands from a user device that are passed through the network portal server(s) 183. Commands from the network portal/service may alternately originate from the network portal/service itself (e.g., as scheduled previously according to settings associated with a user, a user device, or a user account). Various exemplary operations of the Input Management Module 195 are illustrated further in FIG. 2, FIG. 3, and FIG. 4.

The multi-version infrastructure 100 of FIG. 1 may also be associated with an Update Management Module 190, which may be used to manage the process of updating a user account from one version (e.g., Version B) to an updated version (e.g., Version C) of the software application. Such user account updates may be requested by the user device itself (e.g. while logged into to the user account to be updated) or by an “administrator” user account (e.g., through an “administrator” user device or the portal servers 183) with administrative privileges (e.g., through the IDM 180 and/or database 185).

The Update Management Module 190 may include a variety of functions, including a data conversion function. The data conversion function may be used to convert data from a first format associated with the pre-update version of the software application (e.g., Version B in the previous example) into a second format associated with the post-update version of the software application (e.g., Version C in the previous example). The Update Management Module 190 may also include a data transfer function that it can use to transfer data from a first memory associated with a first computer set executing the pre-update version of the software application (e.g., Version B in the previous example).

In some cases, a user account (e.g., through a user device or through the portal servers 183), which may be an “administrator” user account with administrative privileges (e.g., according to the IDM 180 and/or database 185), can transmit an “End of Life” request associated with a particular version of the software update (e.g., Version A) to the Update Management Module 190, which forces a user account update of any user accounts using that version of the software application (e.g., User Account ZA 175) to an updated version of the software application (e.g., Version B). A user device or administrator device can also in some cases force a user account update of a subset of user accounts using that version of the software application (e.g., a group-wide forced update, or a “End of Life” pertaining only to a subset of user accounts).

Various exemplary operations of the Update Management Module 190 are illustrated in FIG. 4. The Input Management Module 195 and/or Update Management Module 190 may each include one or more hardware devices, one or more software elements, or some combination thereof. For example, the Input Management Module 195 and/or Update Management Module 190 may each include one or more computer systems connected via a network or distributed throughout the internet, and may include physical machines, virtual machines, or some combination thereof. The Input Management Module 195 and/or Update Management Module 190 may also include software elements on dedicated computer systems, or on service computer devices (e.g., within one or more of the computer sets), or some combination thereof. The Input Management Module 195 and/or Update Management Module 190 may include software elements, such as API protocols or plugins, in the one or more systems associated with the IDM 180 and/or database 185.

While the User Device X 125, the User Device Y 145, and the User Device Z 165 are all illustrated as laptop computers, each of these user devices, or any other device connected to the multi-version, may be any type of computer device, such as a laptop computer, a desktop computer, a smart television, a home entertainment system, a video game console, a smartphone device, a tablet device, a portable media player device, or a wearable device.

While FIG. 1 illustrates communications between user devices and the multi-version infrastructure 100 going through the internet 155, and communications between user devices and the IDM 180 and database 185 going through the internet 155, these communications may not need to go through the internet 155 in some cases. For example, in some cases, one or more of the user devices may be located within the same private network as at least part of the multi-version infrastructure 100 and/or as at least part of the IDM 180 and/or database 185, meaning that at least some of these communications would need not go through the internet 155. Further, while communications between the multi-version infrastructure 100 and the IDM 180, and between the multi-version infrastructure 100 and the database 185, are shown as going through the internet 155, they may go through a private network in situations where the multi-version infrastructure 100 is hosted within the same network as the IDM 180 and/or database 185.

FIG. 2 is a flow diagram illustrating exemplary account creation operations of an exemplary software upgrade ecosystem. The account creation operations 200 of FIG. 2 may begin at step 213 with a user device (e.g. User Device Q 205) and/or portal server(s) 183 creating a local user account LQQ locally within the User Device Q 205 and/or the portal server(s) 183. The local user account LQQ may be a local user account at the User Device Q 205 and/or the portal server(s) 183 that is then associated with the (yet-to-be-created at step 213 of FIG. 2) user account QQ of the IDM 180. The creation of the local user account QQ is optional, in the account creation operations 200, since a user account QQ may be created at the IDM based on a pre-existing local user account LQQ—the local user account LQQ need not be newly created.

The account creation operations 200 of FIG. 2 may then include, at step 215, the user device (e.g. User Device Q 205) and/or portal server(s) 183 receiving an account creation input requesting the creation of a new user account, User Account QQ, at the IDM 180 and/or database 185. The account creation input may identify that the User Account QQ is to be associated with a particular version of the SaaS service (e.g., Version B), that is to be provided to the User Device Q 205 and/or to the portal server(s) 183 while the User Account QQ is in use and requesting SaaS service.

The account creation input may be an input via a computer input device of the User Device Q 205, the computer input device being a keyboard, a mouse, a touchscreen, a microphone, a camera, a motion sensor, a biometric scanner, or some combination thereof. The account creation input may alternately be a communication from the User Device Q 205 or another computer (such as an “administrator” user device with administrative privileges) to the portal server(s) 183, or an automated function originating at portal server(s) 183. The account creation input may also be a communication from another computer (such as an “administrator” user device with administrative privileges) to the User Device Q 205.

The User Device Q 205 and/or portal server(s) 183 may then, in step 220, generate an IDM account creation request based on the account creation input of step 215 and transmit it either to the IDM 180 (e.g., if the IDM 180 may be operated entirely separately from the multi-version infrastructure 100) or to the input management module 195 (e.g., if the multi-version infrastructure 100 manages the IDM 180).

The IDM account creation request generated in step 220 is then sent either directly to the IDM 180 and/or database 185 to be received in step 240, or alternately may first be sent to the Input Management Module 195 of the multi-version infrastructure 100 to be received in step 225.

In an alternate embodiment (not shown), step 215 and step 220 may both be performed by an “administrator” user device (not shown) that is logged into an “administrator” user account (not shown) with administrative privileges (e.g., as identified in an entry in the IDM 180 and/or database 185 corresponding to the “administrator” user account) to create and/or modify and/or delete other user accounts (e.g., to create User Account QQ 210).

If the IDM account creation request generated and sent in step 220 is transmitted to the Input Management Module 195 of the multi-version infrastructure 100, it may then be received by the Input Management Module 195 in step 225. The Input Management Module 195 may then, in step 230, interpret the IDM account creation request generated in step 220 and received in step 225 and modify the IDM account creation request in a manner that will allow the IDM 180 and/or database 185 to interpret the IDM account creation request. This may be at least partially performed by the portal/browser management function 197 of the Input Management Module 195 if the IDM account creation request was generated and sent by the portal server(s) 183 and/or by the browser accessing the portal hosted by the portal server(s) 183 (e.g., if the SaaS service of the multi-version infrastructure 100 is to be provided to the user account QQ 210 through a website hosted at the portal servers 183). This may at least partially be performed by the API management function 196 of the Input Management Module 195 if the IDM account creation request was generated and sent by the User Device Q 205 (e.g., if the SaaS service of the multi-version infrastructure 100 is to be provided to the user account QQ 210 through a native application running on User Device Q 205) or if the IDM account creation request was generated and sent by the portal server(s) 183 (e.g., if the portal servers 183 interact with the multi-version infrastructure 100 through the API). In some situations, the IDM account creation request needs no changes to be understood by the IDM 180 and/or database 185, in which case the “modifying” operation of step 230 may be skipped. Alternately, instead of modifying the IDM account creation request in step 230, the Input Management Module 195 may generate a new IDM account creation request, where the new IDM account creation request is based on the IDM account creation request generated in step 220 and received in step 225. The Input Management Module 195 may then, in step 235, send the IDM account creation request that results from the operations of step 230 (e.g., either a modified IDM account creation request or new IDM account creation request) to the IDM 180 and/or database 185.

In step 240, the IDM 180 and/or database 185 may receive an IDM account creation request. The IDM account creation request received by the IDM 180 and/or database 185 in step 240 may be the IDM account creation request that was generated in step 220 if, in step 220, the User Device Q 205 or Web Portal Server(s) 183 sent the IDM account creation request of step 220 directly to the IDM 180 and/or database 185. The IDM account creation request received by the IDM 180 and/or database 185 in step 240 may alternately be the IDM account creation request that was sent in step 235 if, in step 220, the User Device Q 205 or Web Portal Server(s) 183 sent the IDM account creation request of step 220 to the Input Management Module 195 of the multi-version infrastructure 100.

Either way, the IDM 180 and/or database 185 may afterward, in step 245, create an entry in the IDM 180 and/or database 185 corresponding to the new User Account QQ 210. Once an entry corresponding to the new User Account QQ 210 is created in the IDM 180 and/or database 185 in step 245, User Account QQ 210 is created both locally at User Device Q 205 and/or Portal Server(s) 183 (e.g., at step 213 or before) as well as within the IDM 180 and/or database 185 (e.g., in step 245).

In some cases, preliminary registration services may then be needed from the SaaS service as part of the account creation operations 200. Thus, step 250 describes generation of an infrastructure account creation request, and transmission of this infrastructure account creation request to the input management module 195. The infrastructure account creation request may be generated and sent by the User device Q 205 (e.g., through an API), the by Portal Server(s) 183 (e.g., through an API and/or through an internet or intranet network portal), or by the IDM 180 and/or Database 185. The infrastructure account creation request may alternately be generated and sent by an “administrator” user device with administrative privileges.

In step 260, the Input Management Module 195 may then receive the infrastructure account creation request generated and sent in step 250. The Input Management Module 195 may then, in step 260, interpret the infrastructure account creation request received in step 260 and generate a version-specific account creation request (e.g., for Version B of the service) based on the infrastructure account creation request, the version-specific account creation request to be understandable by the Version B Computer Set 110 running Version B of the SaaS software application in step 265. The interpretation and generation of step 260 may be at least partially performed by the portal/browser management function 197 of the Input Management Module 195 if the IDM account creation request was generated and sent by the portal server(s) 183 and/or by the browser accessing the portal hosted by the portal server(s) 183 (e.g., if the SaaS service of the multi-version infrastructure 100 is to be provided to the user account QQ 210 through a website hosted at the portal servers 183). The interpretation and generation of step 260 may be at least partially be performed by the API management function 196 of the Input Management Module 195 if the IDM account creation request was generated and sent by the User Device Q 205 (e.g., if the SaaS service of the multi-version infrastructure 100 is to be provided to the user account QQ 210 through a native application running on User Device Q 205) or if the IDM account creation request was generated and sent by the portal server(s) 183 (e.g., if the portal servers 183 interact with the multi-version infrastructure 100 through the API). In some cases, the infrastructure account creation request may be identical to the version-specific account creation request, while in other cases, it may be different.

Once the version-specific account creation request has been generated in step 260, it may then be sent by the Input Management Module 195 to the Version B Computer Set 110, also as part of step 260. The Version B Computer Set 110 may then, in step 270, receive the version-specific account creation request. The version-specific account creation request received in step 265 identifies at least User Account QQ 210, and in some cases, may also identify User Device Q 205 and/or Portal Server(s) 183, depending on which of these devices (or sets of devices) is to receive Version B of the SaaS service. The Version B Computer Set 110 may then use the information in the version-specific account creation request received in step 265 to, in step 270, provide Version B of the SaaS service to the User Device Q 205 and/or to the Portal Server(s) 183 so that either the User Device Q 205 or Portal Server(s) 183 (or some combination thereof) may receive Version B of the SaaS services in step 275 for the benefit of the User Account QQ 210.

In an alternate embodiment, the SaaS service provided in step 280 may pass through the Input Management Module 195 (e.g., using the API management function 196 and/or the portal/browser management function 197) and be interpreted/modified prior to being received by the User Device Q 205 and/or to the Portal Server(s) 183 in step 275.

In an alternate embodiment (not shown), the infrastructure account creation request generated in step 250 may skip the Input Management Module 195 and be sent directly to the Version B Computer Set 110, where it may be received in step 265 as the version-specific account creation request. Further, in another alternate embodiment, the IDM account creation request 220 and the infrastructure account creation request 250 may be sent as a single request to the input management module 195, and the resulting post-receipt operations of both requests as illustrated in FIG. 2 may occur sequentially or in parallel.

While FIG. 2 illustrates account creation for an exemplary User Account QQ 210 to be associated with the Version B Computer Set 110 and User Device Q 205 and/or Portal Server(s) 183, the operations here could be mirrored for another user account to be associated with another computer set associated with another version of the SaaS application (e.g., Version C Computer Set 115 or the Version A Computer Set 105) as well as another user device (e.g., User Device Y 125, User Device Y 145, or User Device Z 165).

FIG. 3 is a flow diagram illustrating exemplary Software-as-a-Service service operations of an exemplary software upgrade ecosystem.

In step 305, the Software-as-a-Service (SaaS) service operations 300 of FIG. 3 may begin with the User Device Q 205 or Portal Server(s) 183 receiving an service input relating to a function to be performed by the version of the SaaS application associated with User Account QQ 210 (e.g., here, Version B as illustrated in FIG. 2).

The service input may be an input via a computer input device of the User Device Q 205, the computer input device being a keyboard, a mouse, a touchscreen, a microphone, a camera, a motion sensor, a biometric scanner, or some combination thereof. The service input may alternately be a communication from the User Device Q 205 or another computer device (such as an “administrator” user device with administrative privileges) to the portal server(s) 183, or an automated function originating at portal server(s) 183. The service input may also be a communication from another computer (such as an “administrator” user device with administrative privileges) to the User Device Q 205.

The User Device Q 205 and/or portal server(s) 183 may then, in step 315, generate an infrastructure service request based on the service input and transmit the infrastructure service request to the input management module 195, which may receive the infrastructure service request at step 325.

In an alternate embodiment (not shown), step 305 and step 310 may both be performed by an “administrator” user device (not shown) that is logged into an “administrator” user account (not shown) with administrative privileges (e.g., as identified in an entry in the IDM 180 and/or database 185 corresponding to the “administrator” user account).

The infrastructure service request received by the Input Management Module at step 325 may alternately be generated and sent in step 320 by one of the IDM 180, the Database 185, the Input Management Module 195, or the Update Management Module 190. The infrastructure service request of step 320 may be based on a service input received in step 310 by one of the IDM 180, the Database 185, the Input Management Module 195, or the Update Management Module 190. This service input may be a communication sent from the User Device Q 205 or another user device (such as an “administrator” user device with administrative privileges) or from the portal server(s) 183.

After the Input Management Module 195 receives the infrastructure service request in step 325, the Input Management Module 195 may then, in step 330, interpret the infrastructure service request and generate a version-specific service request based on the infrastructure service request. In this case, the version-specific service request may be generated to be understandable by the Version B Computer Set 110 running Version B of the SaaS software application, since the User Account QQ 210 is associated with Version B of the SaaS software application as illustrated in the operations of FIG. 2.

The interpretation and generation of step 330 may be at least partially performed by the portal/browser management function 197 of the Input Management Module 195 if the infrastructure service request was generated and sent by the portal server(s) 183 and/or by the browser accessing the portal hosted by the portal server(s) 183 (e.g., if the SaaS service of the multi-version infrastructure 100 is to be provided to the user account QQ 210 through a website hosted at the portal servers 183). The interpretation and generation of step 330 may be at least partially be performed by the API management function 196 of the Input Management Module 195 if the infrastructure service request was generated and sent by the User Device Q 205 (e.g., if the SaaS service of the multi-version infrastructure 100 is to be provided to the user account QQ 210 through a native application running on User Device Q 205) or if the infrastructure service request was generated and sent by the portal server(s) 183 (e.g., if the portal servers 183 interact with the multi-version infrastructure 100 through the API). In some cases, the infrastructure account creation request may be identical to the version-specific account creation request, while in other cases, it may be different.

The Input Management Module 195 may then, as part of step 330, send the version-specific service request generated in step 330 to the Version B Computer Set 110, which may then receive the version-specific service request in step 335. The version-specific service request received in step 335 identifies at least User Account QQ 210, and in some cases, may also identify User Device Q 205 and/or Portal Server(s) 183, depending on which of these devices (or sets of devices) is to receive Version B of the SaaS service. The Version B Computer Set 110 may then use the information in the version-specific service request received in step 335 to, in step 340, provide Version B of the SaaS service to the User Device Q 205 and/or to the Portal Server(s) 183 so that either the User Device Q 205 or Portal Server(s) 183 (or some combination thereof) may receive Version B of the SaaS services in step 345 for the benefit of the User Account QQ 210.

In an alternate embodiment, the SaaS service provided in step 340 may pass through the Input Management Module 195 (e.g., using the API management function 196 and/or the portal/browser management function 197) and be interpreted/modified prior to being received by the User Device Q 205 and/or to the Portal Server(s) 183 in step 345.

In an alternate embodiment (not shown), the infrastructure service request generated in step 315 or the infrastructure service request generated in step 320 may skip the Input Management Module 195 and be sent directly to the Version B Computer Set 110, where it may be received at step 335 as the version-specific service request.

FIG. 4 is a flow diagram illustrating exemplary account update operations of an exemplary software upgrade ecosystem.

The account update operations 400 of FIG. 4 may, optionally, begin with a forced update request in step 405. The forced update request of step 405 may, for example, be an “End of Life” update request as described in relation to FIG. 1, which forces all user accounts in an organization or business to be updated from using a deprecated version (e.g., a “legacy” version such as Version A in FIG. 1) of an SaaS service provided by the multi-version infrastructure 100 to using a newer version (e.g., Version B or Version C of FIG. 1). The forced update request of step 405 may alternately be a forced group update request (e.g., a group-wide forced update, or a “End of Life” pertaining only to a subset of user accounts) or a forced update for only User Account QQ 210. The forced update request of step 405 may originate from an “administrator” user device that is logged into an “administrator” user account with administrative privileges, and may be received in step 405 by at least one of the User Device Q 205 (while logged in to the User Account QQ 210 or otherwise), the Portal Server(s) 183, the IDM 180, the database 185, the Input Management Module 195, or the Update Management Module 190.

The account update operations 400 of FIG. 4 may begin, in step 410, with the User Device Q 205 or the Portal Server(s) 183 receiving an account update input requesting the update of User Account QQ 210 from using a first version of the SaaS software application (e.g., Version B as in FIG. 2 and FIG. 3) via the multi-version infrastructure 100 to using a second version of the SaaS software application (e.g., Version C) via the multi-version infrastructure 100. The account update input may be an input via a computer input device, such as a keyboard, a mouse, a touchscreen, a microphone, a camera, a biometric scanner, or some combination thereof. The account update input may alternately be a communication from the User Device Q 205 or another computer (such as an “administrator” user device with administrative privileges) to the portal server(s) 183, or an automated function originating at portal server(s) 183. The account update input may also be a communication from another computer (such as an “administrator” user device with administrative privileges) to the User Device Q 205.

The User Device Q 205 and/or portal server(s) 183 may then, in step 415, generate an IDM account update request based on the account update input of step 410 and transmit it either to the IDM 180 (e.g., if the IDM 180 may be operated entirely separately from the multi-version infrastructure 100) or to the input management module 195 (e.g., if the multi-version infrastructure 100 manages the IDM 180).

The IDM update request generated in step 415 is then sent either directly to the IDM 180 and/or database 185 to be received in step 240, or alternately may first be sent to the Input Management Module 195 of the multi-version infrastructure 100 in step 225.

In an alternate embodiment (not shown), step 410 and step 415 may both be performed by an “administrator” user device (not shown) that is logged into an “administrator” user account (not shown) with administrative privileges (e.g., as identified in an entry in the IDM 180 and/or database 185 corresponding to the “administrator” user account) to create and/or modify (e.g., update) and/or delete other user accounts (e.g., to create User Account QQ 210).

If the IDM account update request generated and sent in step 415 is transmitted to the Input Management Module 195 of the multi-version infrastructure 100, it may then be received by the Input Management Module 195 in step 420. The Input Management Module 195 may then, in step 425, interpret the IDM account update request generated in step 415 and received in step 420 and modify the IDM account update request in a manner that will allow the IDM 180 and/or database 185 to interpret the IDM account update request. This may be at least partially performed by the portal/browser management function 197 of the Input Management Module 195 if the IDM account update request was generated and sent by the portal server(s) 183 and/or by the browser accessing the portal hosted by the portal server(s) 183 (e.g., if the SaaS service of the multi-version infrastructure 100 is to be provided to the user account QQ 210 through a website hosted at the portal servers 183). This may at least partially be performed by the API management function 196 of the Input Management Module 195 if the IDM account update request was generated and sent by the User Device Q 205 (e.g., if the SaaS service of the multi-version infrastructure 100 is provided to the user account QQ 210 through a native application running on User Device Q 205) or if the IDM account update request was generated and sent by the portal server(s) 183 (e.g., if the portal servers 183 interact with the multi-version infrastructure 100 through the API). In some situations, the IDM account update request needs no changes to be understood by the IDM 180 and/or database 185, in which case the “modifying” operation of step 425 may be skipped. Alternately, instead of modifying the IDM account update request in step 425, the Input Management Module 195 may generate a new IDM account update request, where the new IDM account update request is based on the IDM account update request generated in step 415 and received in step 420. The Input Management Module 195 may then, in step 430, send the IDM account update request that results from the operations of step 425 (e.g., either a modified IDM account update request or new IDM account update request) to the IDM 180 and/or database 185.

In step 435, the IDM 180 and/or database 185 may receive an IDM account update request. The IDM account update request received by the IDM 180 and/or database 185 in step 435 may be the IDM account update request that was generated in step 415 if, in step 415, the User Device Q 205 or Web Portal Server(s) 183 sent the IDM account update request of step 415 directly to the IDM 180 and/or database 185. The IDM account update request received by the IDM 180 and/or database 185 in step 435 may alternately be the IDM account update request that was sent in step 430 if, in step 415, the User Device Q 205 or Web Portal Server(s) 183 sent the IDM account update request of step 415 to the Input Management Module 195 of the multi-version infrastructure 100.

Either way, the IDM 180 and/or database 185 may afterward, in step 440, edit the entry corresponding to a new User Account QQ 210 (e.g., step 245 of FIG. 2) in the IDM 180 and/or database 185 to indicate that User Account QQ 210 is to be associated with Version C of the SaaS application hereafter. Any local user accounts (e.g., User Account LQQ of step 213 of FIG. 2) at the User Device Q 205 and/or at the Portal Server(s) 183 may also be edited at this time.

Once entries corresponding to the User Account QQ 210 have been edited at step 440 at the IDM 180 and/or database 185 (as well as locally at the User Device Q 205 and/or at the Portal Server(s) 183 when applicable), an infrastructure update request may be, at step 445, generated and sent to the Input Management Module 195 of the multi-version infrastructure 100. The infrastructure account upgrade request of step 445 may request that any data associated with User Account QQ 210 be migrated from being accessible by the Version B Computer Set 110 to being accessible by the Version C Computer Set 115, which may involve movement of data between storage devices, pointing computer devices to data elsewhere on a network (e.g., data stored at database 185), or some combination thereof. The infrastructure account update request may be generated and sent by the User device Q 205 (e.g., through an API), the by Portal Server(s) 183 (e.g., through an API and/or through an internet or intranet network portal), or by the IDM 180 and/or Database 185. The infrastructure account update request may alternately be generated and sent by an “administrator” user account (e.g., through an “administrator” user device or the portal servers 183) with administrative privileges (e.g., according to the IDM 180 and/or database 185).

In step 450, the Input Management Module 195 may then receive the infrastructure account update request generated in step 445. The Input Management Module 195 may then, in step 455 interpret the infrastructure account update request received in step 450 and generate a update management account update request based on the infrastructure account update request, the update management account update request to be understandable by the Update Management Module 190 in step 460.

The interpretation and generation of step 455 may be at least partially performed by the portal/browser management function 197 of the Input Management Module 195 if the infrastructure account update request was generated and sent by the portal server(s) 183 and/or by the browser accessing the portal hosted by the portal server(s) 183 (e.g., if the SaaS service of the multi-version infrastructure 100 is provided to the user account QQ 210 through a website hosted at the portal servers 183). The interpretation and generation of step 455 may be at least partially be performed by the API management function 196 of the Input Management Module 195 if the infrastructure account update request was generated and sent by the User Device Q 205 (e.g., if the SaaS service of the multi-version infrastructure 100 is to be provided to the user account QQ 210 through a native application running on User Device Q 205) or if the infrastructure account update request was generated and sent by the portal server(s) 183 (e.g., if the portal servers 183 interact with the multi-version infrastructure 100 through the API). In some cases, the infrastructure account creation request may be identical to the update management account update request, while in other cases, it may be different.

The Input Management Module 195 may then send the update management account update request generated in step 455 to the Update Management Module 190 as part of step 455. The update management account update request sent in step 455 identifies at least User Account QQ 210, and in some cases, may also identify User Device Q 205 and/or Portal Server(s) 183, depending on which of these devices (or sets of devices) is to receive the updated SaaS service (e.g., Version C instead of Version B).

In step 460, Update Management Module 190 receives the update management account update request sent in step 455. In response, the Update Management Module 190 may begin data migration operations as described in step 465. In particular, the Update Management Module 190 may optionally, as part of the migration operations of step 465, convert data from a first format that is associated with the pre-update version of the SaaS software application (e.g., Version B in FIG. 4) to an updated format that is associated with the updated version of the SaaS software application (e.g., Version C in FIG. 4). For example, a conversion may be necessary for Version C of the SaaS software to read data that was produced by Version B of the SaaS software. Such a format conversion may also be performed optionally at the recommendation of Version C of the SaaS software in order to use less memory/storage, perform the SaaS service more quickly/efficiently, store data or perform the SaaS service in a more distributed manner, provide the SaaS service more securely (e.g., the “conversion” operations of step 465 may include encrypting a user's stored data and/or using secure transmission protocols such as Transport Layer Security), or some other reason. The data that undergoes these conversion operations may be stored at a memory locally accessible to the Version B Computer Set 110 (e.g., within storage devices such as hard drives coupled to individual service computers of the Version B Computer Set 110), for example, or it may be stored at database 185, in which case the database 185 may, in step 470, provide the Update Management Module 190 access to data within the database 185. In addition to conversion operations, the Update Management Module 190 may perform data transfer operations as part of the migration operations of step 465, in which the data (that has optionally been converted as part of step 465) that was originally accessible to the computer set associated with the pre-update version of the SaaS software (e.g., here, Version B Computer Set 110) is then made accessible to the computer set associated with the post-update version of the SaaS software application (e.g., the Version C Computer Set 115 in FIG. 4) via file transfer operations, transfer of data pointer information, or some combination thereof. The migration operations may include transfer of data from a first memory locally accessible to the computer set associated with the pre-update version of the SaaS software application (e.g., Version B Computer Set 110 in FIG. 4) and/or from database 185 in step 470 to a second memory accessible to the computer set associated with the updated version of the SaaS software application (e.g., Version C Computer Set 115 in FIG. 4) and/or to database 185 in step 465. The migration operations may include identification of data locations (e.g., pointers to data in a memory and/or hyperlinks to data in a network or on the Internet) rather than, or in addition to, transfer of data.

In some cases, the migration operations of step 465 may be performed instead by updating the individual service computer device(s) that were providing the SaaS service to the User Account QQ 210 (e.g., through the User Device Q 205 and/or Portal Servers 183). For example, if a first service computer device within Version B Computer Set 110 was initially providing Version B of the SaaS service to the User Account QQ 210, the migration operations of step 465 may be performed by upgrading the first service computer device to Version C of the SaaS service, thus making the first service computer device subsequently part of the Version C Computer Set 115 while maintaining access to the same data that the first service computer device had access to previously. The migration operations of step 465 may thus be performed without any transfer of data or data pointers. The conversion operations of step 465 may still apply in this type of migration scenario.

In some cases, the SaaS service may need to perform certain update operations at the Version C Computer Set 115 after the other migration operations are complete. Thus, in step 475, the Input Management Module 195 may also generate a version-specific update request. The version-specific update request may be based on interpretation of the infrastructure account update request (sent in step 445 and received by the IDM 180 and/or database 185 in step 450) as described in relation to step 455. In some cases, the infrastructure account update request may be identical to the version-specific account creation request, while in other cases, it may be different.

Once the version-specific account update request has been generated in step 475, it may then be sent by the Input Management Module 195 to the Version C Computer Set 115, also as part of step 475. The Version C Computer Set 115 may then, in step 485, receive the version-specific account update request. The version-specific account update request received in step 480 identifies at least User Account QQ 210, and in some cases, may also identify User Device Q 205 and/or Portal Server(s) 183, depending on which of these devices (or sets of devices) is to receive Version C of the SaaS service. The Version C Computer Set 115 may then use the information in the version-specific account update request received in step 480 to, in step 485, provide Version C of the SaaS service to the User Device Q 205 and/or to the Portal Server(s) 183 so that either the User Device Q 205 or Portal Server(s) 183 (or some combination thereof) may receive Version C of the SaaS services in step 490 for the benefit of the User Account QQ 210.

In an alternate embodiment, the SaaS service provided in step 280 may pass through the Input Management Module 195 (e.g., using the API management function 196 and/or the portal/browser management function 197) and be interpreted/modified prior to being received by the User Device Q 205 and/or to the Portal Server(s) 183 in step 490.

Once the account update operations 400 of FIG. 4 are complete, User Account QQ 210 may conduct regular SaaS Service operations as illustrated in FIG. 3, only with some operations (e.g., step 335 and step 340) performed by the Version C Computer Set 115 instead of the Version B Computer Set 110.

FIG. 5 illustrates an exemplary computing system 500 that may be used to implement an embodiment of the present invention. The computing system 500 of FIG. 5 includes one or more processors 510 and memory 510. Main memory 510 stores, in part, instructions and data for execution by processor 510. Main memory 510 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 510 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 510.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for software version management, the method comprising:
receiving a first service request from a first user account, the first service request requesting that a first service be provided to a first recipient computer device associated with the first user account, the first service to be a provided by a first version of a Software-as-a-Service software application;
generating a first version-specific request based on the first service request; and
transmitting the first version-specific request to a first computer set, the first computer set including one or more service computer devices, where each service computer device of the first computer set executes first instructions associated with the first version of the Software-as-a-Service software application, and wherein execution of the first instructions by the first computer set provides the first service to the first recipient computer device.

2. The method of claim 1, wherein the first recipient computer device is a personal user device that is logged into a local user account associated with the first user account, and further comprising interpreting an application programming interface (API) within the first service request prior to generating the first version-specific request.

3. The method of claim 1, wherein the first recipient computer device is a portal server that serves a network-based portal that is accessed by a personal user device through a local user account associated with the first user account, and further comprising interpreting at least one of a network-based interface or an application programming interface (API) used by the first service request prior to generating the first version-specific request.

4. The method of claim 1, further comprising:
receiving a second service request from a second user account, the second service request requesting that a second service be provided to a second recipient computer device associated with the second user account, the second service to be a provided by a second version of a Software-as-a-Service software application;
generating a second version-specific request based on the second service request; and
transmitting the second version-specific request to a second computer set, the second computer set including one or more service computer devices, where each service computer device of the second computer set executes instructions associated with the second version of the Software-as-a-Service software application, and wherein execution of the instructions by the second computer set provides the second service to the second recipient computer device.

5. The method of claim 4, wherein the first recipient computer device is the second recipient computer device.

6. The method of claim 4, wherein the first user account and the second user account are both associated with a single user.

7. The method of claim 1, further comprising:
receiving a first upgrade request associated with the first user account;
locating a first user account dataset including personal data associated with the first user account; and
making the first user account dataset accessible to an updated computer set, the update computer set including one or more service computer devices, where each service computer device of the update computer set executes updated instructions associated with an updated version of the Software-as-a-Service software application, and wherein execution of the updated instructions by the updated computer set provides an updated service to the first recipient computer device.

8. The method of claim 7, wherein making the first user account dataset accessible to the updated computer set includes converting at least part of the first user account dataset from a first format that is associated with the first version of the Software-as-a-Service software application to an updated format that is associated with the updated version of the Software-as-a-Service software application.

9. The method of claim 7, wherein making the first user account dataset accessible to a update computer set includes copying data from a first memory locally accessible to at least some of the first computer set to an update memory locally accessible to at least some of the updated computer set.

10. The method of claim 7, wherein making the first user account dataset accessible to a updated computer set includes identifying a first data chunk that is stored at a data storage system to the updated computer set, the data storage system communicatively coupled to both the first computer set and to the update computer set, the first data chunk including at least part of the first user account dataset.

11. The method of claim 7, wherein the first upgrade request is received from the first user account.

12. The method of claim 7, wherein the first upgrade request is received from an administrative user account associated with an organization associated with the first user account.

13. A system for software version management, comprising:
a first computer set, the first computer set including a first one or more network-connected service computer devices executing a first set of instructions stored at a first memory associated with the first computer set, the first set of instructions for executing a first version of a software-as-a-service application to provide a first service to a first recipient computer device that is logged into the first user account upon receiving a first service request from the first user account; and
a second computer set, the second computer set including a second one or more network-connected computer devices executing a second set of instructions stored at a second memory associated with the second computer set, the second set of instructions for executing a second version of a software-as-a-service application to provide a second service to a second recipient computer device that is logged into the second user account upon receiving a second service request from the second user account.

14. The system of claim 13, further comprising a data storage system communicatively coupled to the first computer set and also communicatively coupled to the second computer set, the data storage system storing a first user dataset associated with the first user account and also storing a second user dataset associated with the second user account.

15. The system of claim 13, wherein the data storage system is associated with an identity management system.

16. The system of claim 14, wherein the first user account and the second user account are associated with a single user, and wherein the first user dataset is the same as the second user dataset.

17. The system of claim 13, wherein the first recipient computer device and the second recipient computer device are the same recipient computer device.

18. The system of claim 13, further comprising an input management module that interprets the first service request and the second service request by interpreting at least one of an application programming interface (API) request or a network interface request.

19. The system of claim 13, further comprising an Update Management Module, wherein execution of the Update Management Module:
adjusts the first set of instructions so that the first version of a software-as-a-service application no longer provides the first service to the first recipient computer device, and
adjusts the second set of instructions so that the second version of a software-as-a-service application provides an updated version of the first service to the first recipient computer device.

20. A non-transitory computer-readable storage medium, having embodied thereon a program executable by a processor to perform a method for software version management, the method comprising:
receiving a first service request from a first user account, the first service request requesting that a first service be provided to a first recipient computer device associated with the first user account, the first service to be a provided by a first version of a Software-as-a-Service software application;
generating a first version-specific request based on the first service request; and
transmitting the first version-specific request to a first computer set, the first computer set including one or more service computer devices, where each service computer device of the first computer set executes first instructions associated with the first version of the Software-as-a-Service software application, and wherein execution of the first instructions by the first computer set provides the first service to the first recipient computer device.
